(19) United States
(12) Patent Application Publication
(10) Pub. No.: US 2005/0288433 A1
(43) Pub. Date: Dec. 29, 2005

(54) Method for preparing silver-containing polyesters

(75) Inventors: Dong-Hwang Chen, Tainan City (TW); Chao-Chuan Cheng, Hsin-Chu City (TW); Li-Chi Lin, Hua-Lian Hsien (TW)

Correspondence Address: DARBY & DARBY P.C., P. O. BOX 5257, NEW YORK, NY, 10150-5257, US

(73) Assignee: EVEREST TEXTILE CO., LTD., Tainan Hsien (TW)

(21) Appl. No.: 11/166,541

(22) Filed: Jun. 24, 2005

(30) Foreign Application Priority Data
Jun. 29, 2004 (TW) 093119127

(51) Int. Cl. C08G 63/48

(52) U.S. Cl. 525/50

(57) ABSTRACT

A method for preparing silver-containing polyesters includes: (a) preparing a reaction mixture of a carboxylic acid and an alcohol; (b) conducting esterification and polycondensation of the reaction mixture; and (c) adding a silver-containing agent into the reaction mixture so as to conduct the reduction of silver ions to silver particles in the reaction mixture.

### CROSS-REFERENCE TO RELATED APPLICATIONS

This application claims priority of Taiwanese application no. 093119127, filed on Jun. 29, 2004.

### BACKGROUND OF THE INVENTION

1. Field of the Invention

This invention relates to a method for preparing silver-containing polyesters, more particularly to a method for preparing silver-containing polyesters involving conducting reduction of silver ions to silver particles in a reaction mixture of a carboxylic acid and an alcohol during the synthetic process of the so called silver-containing polyester.

2. Description of the Related Art

Silver (Ag) has been widely used in antibacterial materials for inhibiting bacteria and mold, such as antibacterial polyesters. One conventional method for preparing the antibacterial polyesters involves kneading silver particles and polyesters, so as to disperse the silver particles in the polyesters. Another conventional method for preparing the antibacterial polyesters involves adding silver particles into a reaction mixture during a synthetic process of the silver-containing polyester.

In the above conventional methods, in order to maintain the size of silver particles in nano-scale in the polyester, nano-scale silver particles have to be prepared prior to dispersion of the silver particles in the polyesters. Hence, the production cost is relatively high. In addition, during kneading of the silver particles and the polyesters, especially in the production of high silver content polyesters, the silver particles tend to agglomerate, which results in poor dispersion of the silver particles in the polyesters. Furthermore, the additional kneading process results in a decrease in the yield of the silver-containing polyesters.

### SUMMARY OF THE INVENTION

The object of the present invention is to provide a method for preparing silver-containing polyesters that is clear of the abovementioned drawbacks of the prior art.

According to this invention, a method for preparing silver-containing polyesters includes: (a) preparing a reaction mixture of a carboxylic acid and an alcohol; (b) conducting esterification and polycondensation of the reaction mixture; and (c) adding a silver-containing agent into the reaction mixture so as to conduct the reduction of silver ions to silver particles in the reaction mixture.

### DETAILED DESCRIPTION OF THE PREFERRED EMBODIMENT

The preferred embodiment of the method for preparing silver-containing polyesters according to this invention includes the steps of: (a) preparing a reaction mixture of a carboxylic acid and an alcohol; (b) conducting esterification and polycondensation of the reaction mixture; and (c) adding a silver-containing agent into the reaction mixture so as to conduct the reduction of silver ions to silver particles in the reaction mixture.

Carboxylic acids suitable for the preferred embodiment are dicarboxylic acids. The dicarboxylic acids suitable for the preferred embodiment are those commonly used in polyester preparation, and can be chosen by one skilled in the art according to the required and desired polyester products. Preferably, the dicarboxylic acid is selected from the group consisting of terephthalic acid and isophthalic acid.

Alcohols suitable for the preferred embodiment are glycols. The glycols suitable for the preferred embodiment are those commonly used in polyester preparation, and can be chosen and determined by one skilled in the art according to the required and desired polyester product s. Preferably, the glycol is selected from the group consisting of ethylene glycol, polyethylene glycol, 1,4-butylene glycol, and 1,3-propylene glycol.

For example, isophthalic acid and ethylene glycol are chosen as starting materials for preparing polyethylene isophthalate, whereas terephthalic acid and butylene glycol are chosen as starting materials for preparing polybutylene terephthalate.

Preferably, the esterification of the reaction mixture of the dicarboxylic acid and the glycol is conducted at a temperature ranging from 220° C. to 260° C. The polycondensation of the reaction mixture after completion of esterification is conducted at a temperature ranging from 260° C. to 280° C.

When the silver-containing agent is added into the reaction mixture, the silver-containing agent may be a silver compound or a silver ion-containing solution formed by dissolving the silver compound into a solvent. Preferably, the silver compound is selected from the group consisting of AgNO₃₍ₛ₎, AgClO₄₍ₛ₎, Ag₂SO₄₍ₛ₎, and Ag₂CO₃₍ₛ₎. The solvent suitable for dissolving the silver compound to form the silver ion-containing solution may be selected from the group consisting of alcohols, glycols and water.

Addition timing of the silver-containing agent into the reaction mixture can be at any step of the entire synthetic process of the polyester including during the preparation of the reaction mixture of the dicarboxylic acid and the glycol, after completion of the preparation of the reaction mixture and before esterification of the reaction mixture, during the esterification of the reaction mixture, after completion of the esterification of the reaction mixture and before polycondensation of the reaction mixture, or during the polycondensation of the reaction mixture.

When the silver-containing agent is added into the reaction mixture after completion of the esterification and before the polycondensation of the reaction mixture, or during the polycondensation of the reaction mixture, the silver-containing agent is preferably the silver ion-containing solution as described above.

The silver ions provided by the silver-containing agent will be reduced by the alcohols or glycols at a temperature higher than 120° C. The silver ions provided by the silver-containing agent can be reduced by the alcohols or by the glycols at the reaction temperature during the esterification or the polycondensation of the reaction mixture of the carboxylic acid and the glycol.

### EXAMPLES

### Example 1

0.42 kg of ethylene glycol and 0.864 kg of terephthalic acid were fed to a mixer with agitation so as to form a reaction mixture. The reaction mixture was then poured into an esterification vessel. The esterification vessel was heated to 260° C. 0.157 g of AgNO₃₍ₛ₎ was then added into the esterification vessel. Esterification was conducted at 260° C. for 3 hours so as to form an intermediate. The intermediate was subsequently fed to a polycondensation vessel. The polycondensation vessel was then heated to 273° C. in a vacuum condition to initiate polycondensation. Polycondensation was conducted for 3 hours to obtain a silver-containing polyester melt. The silver-containing polyester melt was fed to a pelletizer and was pelletized into silver-containing polyester pellets having silver particle sizes ranging from 10 to 500 nm.

### Example 2

0.157 g of AgNO₃₍ₛ₎ was dissolved in 0.02 liter of ethylene glycol at room temperature to form an AgNO₃ solution. 0.42 kg of ethylene glycol and 0.864 kg of terephthalic acid were fed to a mixer with agitation so as to form a reaction mixture. The reaction mixture was then poured into an esterification vessel. The esterification vessel was heated to 260° C. The AgNO₃ solution was then added into the esterification vessel. Esterification was conducted at this temperature for 3 hours so as to form an intermediate. The intermediate was subsequently fed to a polycondensation vessel. The polycondensation vessel was then heated to 273° C. in a vacuum condition to initiate polycondensation. Polycondensation was conducted for 3 hours to obtain a silver-containing polyester melt. The silver-containing polyester melt was fed to a pelletizer and was pelletized into silver-containing polyester pellets having silver particle sizes ranging from 10 to 500 nm.

### Example 3

0.157 g of AgNO₃₍ₛ₎ was dissolved in 0.02 liter of ethylene glycol at room temperature to form an AgNO₃ solution. 0.42 kg of ethylene glycol and 0.864 kg of terephthalic acid were fed to a mixer with agitation so as to form a reaction mixture. The reaction mixture was then poured into an esterification vessel. The esterification vessel was heated to 260° C. Esterification was conducted at this temperature for 3 hours so as to form an intermediate. The intermediate was subsequently fed to a polycondensation vessel. The AgNO₃ solution was added into the polycondensation vessel with agitation over a period of 10 minutes. The polycondensation vessel was then heated to 273° C. in a vacuum condition to initiate polycondensation. Polycondensation was conducted for 3 hours to obtain a silver-containing polyester melt. The silver-containing polyester melt was fed to a pelletizer and was pelletized into silver-containing polyester pellets having silver particle sizes ranging from 10 to 100 nm.

### Example 4

0.157 g of AgNO₃₍ₛ₎ was dissolved in 0.02 liter of ethylene glycol at room temperature to form an AgNO₃ solution. 0.42 kg of ethylene glycol and 0.864 kg of terephthalic acid were fed to a mixer with agitation so as to form a reaction mixture. The reaction mixture was then poured into an esterification vessel. The esterification vessel was heated to 260° C. Esterification was conducted at this temperature for 3 hours so as to form an intermediate. The intermediate was subsequently fed to a polycondensation vessel. The polycondensation vessel was heated to 270° C. in a vacuum condition to initiate polycondensation. After the temperature of the polycondensation vessel was elevated to 273° C., the AgNO₃ solution was added into the polycondensation vessel with agitation. The polycondensation took about 3.5 hours to complete. After completing the polycondensation, a silver-containing polyester melt was obtained. The silver-containing polyester melt was fed to a pelletizer and was pelletized into silver-containing polyester pellets having silver particle sizes ranging from 10 to 100 nm.

### Example 5

This Example differs from Example 3 in that addition of AgNO₃ solution into the reaction mixture was performed during preparation of the reaction mixture. The silver-containing polyester melt thus formed was fed to a pelletizer and was pelletized into silver-containing polyester pellets having silver particle sizes ranging from 10 to 500 nm.

### Example 6

This Example differs from Example 3 in that 42 g polyethylene glycol was added into the reaction mixture during preparation of the reaction mixture. The silver-containing polyester melt thus formed was fed to a pelletizer and was pelletized into silver-containing polyester pellets having silver particle sizes ranging from 10 to 100 nm.

### Example 7

This Example differs from Example 3 in that 0.42 kg ethylene glycol was replaced with 0.61 kg 1,4-butylene glycol for preparing the reaction mixture and that 1,4-butylene glycol was used as the solvent for dissolving AgNO₃. The silver-containing polyester melt thus formed was fed to a pelletizer and was pelletized into silver-containing polyester pellets having silver particle sizes ranging from 10 to 100 nm.

### Example 8

This Example differs from Example 3 in that 0.42 kg ethylene glycol was replaced with 0.51 kg 1,3-propylene glycol for preparing the reaction mixture and that 1,3-propylene glycol was used as the solvent for dissolving AgNO₃. The silver-containing polyester melt thus formed was fed to a pelletizer and was pelletized into silver-containing polyester pellets having silver particle sizes ranging from 10 to 100 nm.

According to the method of this invention, since silver particles are formed in situ in the reaction mixture or in the intermediate during the production of polyesters, the pre-formation step of the silver particles included in the conventional methods can be omitted. In addition, the polyesters thus formed per se can be used as a dispersing agent for preventing the silver particles from agglomeration in the method according to this invention.

While the present invention has been described in connection with what is considered the most practical and preferred embodiment, it is understood that this invention is not limited to the disclosed embodiment but is intended to cover various arrangements included within the spirit and scope of the broadest interpretation and equivalent arrangements.

1. A method for preparing silver-containing polyesters, comprising:
(a) preparing a reaction mixture of a carboxylic acid and an alcohol;
(b) conducting esterification and polycondensation of the reaction mixture; and
(c) adding a silver-containing agent into the reaction mixture so as to conduct the reduction of silver ions to silver particles in the reaction mixture.

2. The method as claimed in claim 1, wherein the silver-containing agent is added into the reaction mixture during the esterification of the reaction mixture.

3. The method as claimed in claim 1, wherein the silver-containing agent is added into the reaction mixture after completion of the esterification and before the polycondensation of the reaction mixture.

4. The method as claimed in claim 1, wherein the silver-containing agent is added into the reaction mixture during the polycondensation of the reaction mixture.

5. The method as claimed in claim 1, wherein the silver-containing agent is a silver ion containing solution formed by dissolving a silver compound into a solvent.

6. The method as claimed in claim 5, wherein the silver compound is selected from the group consisting of AgNO₃₍ₛ₎, AgClO₄₍ₛ₎, Ag₂SO₄₍ₛ₎, and Ag₂CO₃₍ₛ₎.

7. The method as claimed in claim 5, wherein the solvent is selected from the group consisting of alcohols, glycols and water.

8. The method as claimed in claim 1, wherein the carboxylic acid is a dicarboxylic acid.

9. The method as claimed in claim 8, wherein the dicarboxylic acid is selected from the group consisting of terephthalic acid and isophthalic acid.

10. The method as claimed in claim 1, wherein the alcohol is a glycol.

11. The method as claimed in claim 10, wherein the glycol is selected from the group consisting of ethylene glycol, polyethylene glycol, 1,4-butylene glycol, and 1,3-propylene glycol.

12. The method as claimed in claim 1, wherein the esterification of the reaction mixture is conducted at a temperature ranging from 220° C. to 260° C.

13. The method as claimed in claim 1, wherein the polycondensation of the reaction mixture is conducted at a temperature ranging from 260° C. to 280° C.

14. The method as claimed in claim 1, wherein the silver-containing agent is a silver compound.

15. The method as claimed in claim 14, wherein the silver compound is selected from the group consisting of AgNO₃₍ₛ₎, AgClO₄₍ₛ₎, Ag₂SO₄₍ₛ₎, and Ag₂CO₃₍ₛ₎.

16. The method as claimed in claim 1, wherein the silver-containing agent is added into the react ion mixture during the preparation of the reaction mixture.
